(19) United States
(12) Patent Application Publication
(10) Pub. No.: US 2009/0207691 A1
(43) Pub. Date: Aug. 20, 2009

(54) Dissolution test vessel with rotational agitation

(75) Inventor: Jeremy Fetvedt, Raleigh, NC (US)

Correspondence Address: Varian Inc.;Legal Department, 3120 Hansen Way D-102, Palo Alto, CA, 94304, US

(73) Assignee: Varian, Inc.

(21) Appl. No.: 12/069,929

(22) Filed: Feb. 14, 2008

(51) Int. Cl. B01F 1/00; B01L 3/00; B01J 19/00

(52) U.S. Cl. 366/220; 422/102; 422/255

(57) ABSTRACT

A rotatable vessel includes a rotary member secured to a vessel body and drivable to rotate the vessel about a central axis. The rotary member may be supported by a bearing at a dissolution test apparatus at which the vessel is mounted. The dissolution test apparatus may include a drive system coupled to the rotary member for driving the rotation of the vessel at a desired speed or according to a desired speed profile. The rotation of the vessel agitates media contained in the vessel, thus eliminating the need for a stirring element operating within the vessel.

### CROSS REFERENCE TO RELATED APPLICATIONS

This application is related to the dissolution testing of analyte-containing media as well as following U.S. patent applications titled “Dissolution Test Vessel with Integrated Centering Geometry” and “Captive Evaporation Cover for Dissolution Systems”, which are commonly assigned by the same inventor to the assignee of the present disclosure. These U.S. patent applications are being filed concurrently with the present patent application on Feb. 14, 2008.

### FIELD OF THE INVENTION

The present invention relates generally to dissolution testing of analyte-containing media. More particularly, the present invention relates to rotation of a vessel utilized to contain dissolution media.

### BACKGROUND OF THE INVENTION

Dissolution testing is often performed as part of preparing and evaluating soluble materials, particularly pharmaceutical dosage forms (e.g., tablets, capsules, and the like) consisting of a therapeutically effective amount of active drug carried by an excipient material. Typically, dosage forms are dropped into test vessels that contain dissolution media of a predetermined volume and chemical composition. For instance, the composition may have a pH factor that emulates a gastro-intestinal environment. Dissolution testing can be useful, for example, in studying the drug release characteristics of the dosage form or in evaluating the quality control of the process used in forming the dose. To ensure validation of the data generated from dissolution-related procedures, dissolution testing is often carried out according to guidelines approved or specified by certain entities such as United States Pharmacopoeia (USP), in which case the testing must be conducted within various parametric ranges. The parameters may include dissolution media temperature, the amount of allowable evaporation-related loss, and the use, position and speed of agitation devices, dosage-retention devices, and other instruments operating in the test vessel.

As a dosage form is dissolving in the test vessel of a dissolution system, optics-based measurements of samples of the solution may be taken at predetermined time intervals through the operation of analytical equipment such as a spectrophotometer. The analytical equipment may determine analyte (e.g. active drug) concentration and/or other properties. The dissolution profile for the dosage form under evaluation—i.e., the percentage of analytes dissolved in the test media at a certain point in time or over a certain period of time—can be calculated from the measurement of analyte concentration in the sample taken. In one specific method employing a spectrophotometer, sometimes referred to as the sipper method, dissolution media samples are pumped from the test vessel(s) to a sample cell contained within the spectrophotometer, scanned while residing in the sample cell, and in some procedures then returned to the test vessel(s). In another more recently developed method, sometimes referred to as the in situ method, a fiber-optic “dip probe” is inserted directly in a test vessel. The dip probe includes one or more optical fibers that communicate with the spectrophotometer. In the in situ technique, the spectrophotometer thus does not require a sample cell as the dip probe serves a similar function. Measurements are taken directly in the test vessel and thus optical signals rather than liquid samples are transported between the test vessel and the spectrophotometer via optical fibers.

The apparatus utilized for carrying out dissolution testing typically includes a vessel plate having an array of apertures into which test vessels are mounted. When the procedure calls for heating the media contained in the vessels, a water bath is often provided underneath the vessel plate such that each vessel is at least partially immersed in the water bath to enable heat transfer from the heated bath to the vessel media. In one exemplary type of test configuration (e.g., USP-NF Apparatus 1), a cylindrical basket is attached to a metallic drive shaft and a pharmaceutical sample is loaded into the basket. One shaft and basket combination is manually or automatically lowered into each test vessel mounted on the vessel plate, and the shaft and basket are caused to rotate. In another type of test configuration (e.g., USP-NF Apparatus 2), a blade-type paddle is attached to each shaft, and the pharmaceutical sample is dropped into each vessel such that it falls to the bottom of the vessel. When proceeding in accordance with the general requirements of Section <711> (Dissolution) of USP24-NF19, each shaft must be positioned in its respective vessel so that its axis is not more than 2 mm at any point from the vertical axis of the vessel.

It therefore has been conventional in dissolution testing that shaft-driven, rotating instruments such as paddles, baskets or the like extend into and operate within vessels while dosage forms are dissolving. Unfortunately, like other instruments that may be inserted into vessels such as fiber-optic probes, conventional instruments utilized to agitate the dissolution media may engender hydrodynamic effects adverse to the acquisition of accurate dissolution data. Moreover, such instruments need to be precisely located within the vessel, and frequently recalibrated, to ensure validation of the dissolution data acquired during their operation in the vessels. Additionally, the presence of such instruments in the vessels impairs visual inspection of the contents of the vessels and access to the vessels. Additionally, when it is desired to utilize vessel covers to minimize evaporation loss from the vessels, the vessel covers must have holes to accommodate the operation of such instruments such that evaporation loss cannot be eliminated or at least reduced to an optimal degree.

Accordingly, there is a need for methods and apparatus for agitating dissolution media in a vessel while eliminating the disadvantages attending the use of instruments residing directly in the vessel.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a rotatable vessel includes a vessel body and a rotary member. The vessel body includes a cylindrical section coaxially disposed about a central axis of the vessel and circumscribing an upper opening, a bottom section adjoining the cylindrical section at an axial end of the cylindrical section opposite to the upper opening, and a flanged section extending radially outward from the cylindrical section proximate to the upper opening. The rotary member is secured to the flanged section and includes a drive coupling section configured to be coupled to a drive device, wherein the vessel body and the rotary member are rotatable together about the central axis. The rotary member further includes a movable bearing portion configured to be coupled to a stationary bearing portion supporting the rotary member.

According to another implementation a dissolution test apparatus includes a vessel support member, a rotary member, a drive device, and a drive linkage. The vessel support member includes a vessel mounting site. The vessel mounting site has an aperture and includes a stationary bearing portion mounted at the aperture. The rotary member is rotatable about a central axis of the aperture and includes a movable bearing portion coupled to the stationary bearing portion. The drive device is mounted to the vessel support member. The drive linkage couples the drive device to the rotary member such that the drive device actuates rotation of the rotary member about the central axis and relative to the stationary bearing portion via the drive linkage.

According to another implementation, a vessel is mounted at the vessel mounting site of the dissolution test apparatus. A flanged section of the vessel is secured to the rotary member such that the vessel is rotatable with the rotary member about the central axis.

According to another implementation, a method is provided for agitating dissolution media contained in a vessel mounted at a dissolution test apparatus. A rotary member is secured to a flanged section of the vessel. The vessel is installed at the dissolution test apparatus by inserting the vessel through an aperture of a vessel support member of the dissolution test apparatus, and coupling a movable bearing portion of the rotary member to a stationary bearing portion of the vessel support member. The rotary member is coupled to a drive device. The vessel is rotated about a central axis of the vessel by operating the drive device. The rotation agitates the dissolution media contained in the vessel.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a dissolution test apparatus that may be modified to receive rotatable vessels according to one or more implementations taught in the present disclosure.

FIG. 2 is a cross-sectional elevation view of an example of a rotatable vessel according to one or more implementations taught in the present disclosure.

FIG. 3 is a cross-sectional elevation view of another example of a rotatable vessel according to one or more implementations taught in the present disclosure.

FIG. 4 is an elevation view of an example of a rotary member that may be provided with a rotatable vessel according to an implementation taught in the present disclosure.

FIG. 5 is an elevation view of another example of a rotary member that may be provided with a rotatable vessel according to an implementation taught in the present disclosure.

FIG. 6 is a perspective view of an example of a dissolution test apparatus that rotates one or more vessels according to an implementation taught in the present disclosure.

FIG. 7 is a schematic top plan view of another example of a dissolution test apparatus that rotates one or more vessels according to an implementation taught in the present disclosure.

### DETAILED DESCRIPTION OF THE INVENTION

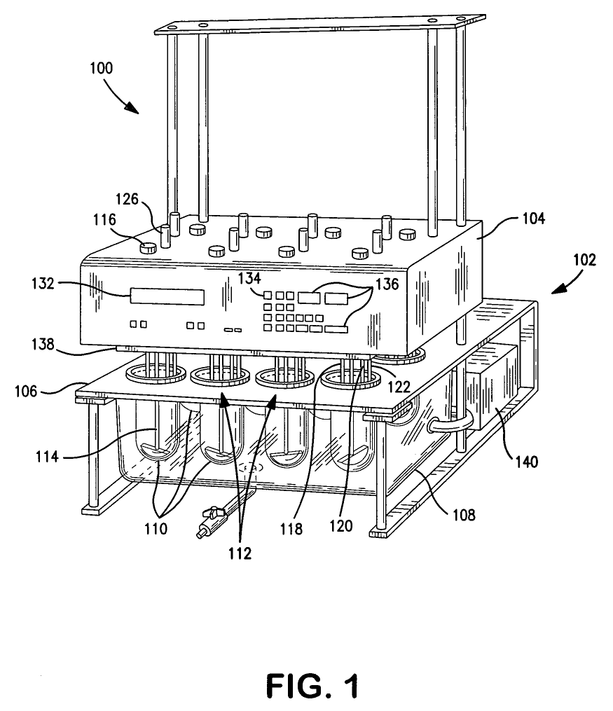

FIG. 1 is a perspective view of an example of a dissolution test apparatus 100 according to an implementation of the present disclosure. The dissolution test apparatus 100 may include a frame assembly 102 supporting various components such as a main housing, control unit or head assembly 104, a vessel support member (e.g., a plate, rack, etc.) 106 below the head assembly 104, and a water bath container 108 below the vessel support member 106. The vessel support member 106 supports a plurality of vessels 110 extending into the interior of the water bath container 108. FIG. 1 illustrates eight vessels 110 by example, but it will be understood that more or less vessels 110 may be provided. Conventionally, the vessels 110 may be locked and centered in place on the vessel support member 106 by means such as ring lock devices or clamps (not shown) at a plurality of vessel mounting sites 112. Alternatively, the vessels 110 themselves may be configured to have centering capability, as disclosed for example in U.S. Pat. Nos. 6,562,301 and 6,673,319, assigned to the assignee of the present disclosure. In either case, it is conventional that the vessels 110 be mounted at the vessel support member 106 in fixed positions such that the vessels 110 cannot move. Vessel covers (not shown) may be provided to prevent loss of media from the vessels 110 due to evaporation, volatility, etc. Optionally, the vessel covers may be coupled to the head assembly 104 and movable by motorized means into position over the upper openings of the vessels 110, as disclosed for example in U.S. Pat. No. 6,962,674, assigned to the assignee of the present disclosure. Water or other suitable heat-carrying liquid medium may be heated and circulated through the water bath container 108 by means such as an external heater and pump module 140, which may be included as part of the dissolution test apparatus 100. Alternatively, the dissolution test apparatus 100 may be a waterless heating design in which each vessel 110 is directly heated by some form of heating element disposed in thermal contact with the wall of the vessel 110, as disclosed for example in U.S. Pat. Nos. 6,303,909 and 6,727,480, assigned to the assignee of the present disclosure.

The head assembly 104 may include mechanisms for operating or controlling various components that operate in the vessels 110 (in situ operative components). For example, the head assembly 104 conventionally supports stirring elements 114 that include respective motor-driven spindles and paddles operating in each vessel 110. Individual clutches 116 may be provided to alternately engage and disengage power to each stirring element 114 by manual, programmed or automated means. The head assembly 104 also includes mechanisms for driving the rotation of the stirring elements 114. As described in more detail below, implementations taught in the present disclosure eliminate the need for stirring elements 114 and associated components.

The head assembly 104 may also include mechanisms for operating or controlling media transport cannulas that provide liquid flow paths between liquid lines and corresponding vessels 110. In the present context, the term “between” encompasses a liquid flow path directed from a liquid line into a vessel 110 or a liquid flow path directed from a vessel 110 into a liquid line. Accordingly, the media transport cannulas may include media dispensing cannulas 118 for dispensing media into the vessels 110 and media aspirating cannulas 120 for removing media from the vessels 110. The head assembly 104 may also include mechanisms for operating or controlling other types of in situ operative components 122 such as fiber-optic probes for measuring analyte concentration, temperature sensors, pH detectors, dosage form holders (e.g., USP-type apparatus such as baskets, nets, cylinders, etc.), video cameras, etc. A dosage delivery module 126 may be utilized to preload and drop dosage units (e.g., tablets, capsules, or the like) into selected vessels 110 at prescribed times and media temperatures. Additional examples of mechanisms for operating or controlling various in situ operative components are disclosed for example in above-referenced U.S. Pat. No. 6,962,674.

The head assembly 104 may include a programmable systems control module for controlling the operations of various components of the dissolution test apparatus 100 such as those described above. Peripheral elements may be located on the head assembly 104 such as an LCD display 132 for providing menus, status and other information; a keypad 134 for providing user-inputted operation and control of spindle speed, temperature, test start time, test duration and the like; and readouts 136 for displaying information such as RPM, temperature, elapsed run time, vessel weight and/or volume, or the like.

The dissolution test apparatus 100 may further include one or more movable components for lowering operative components 118, 120, 122 into the vessels 110 and raising operative components 118, 120, 122 out from the vessels 110. The head assembly 104 may itself serve as this movable component. That is, the entire head assembly 104 may be actuated into vertical movement toward and away from the vessel support member 106 by manual, automated or semi-automated means. Alternatively or additionally, other movable components 138 such as a driven platform may be provided to support one or more of the operative components 118, 120, 122 and lower and raise the components 118, 120, 122 relative to the vessels 110 at desired times. One type of movable component may be provided to move one type of operative component while another type of movable component may be provided to move another type of operative component (e.g., media dispensing cannulas 118 and/or media aspirating cannulas 120). Moreover, a given movable component may include means for separately actuating the movement of a given type of operative component 118, 120, 122. For example, each media dispensing cannula 118 or media aspirating cannula 120 may be movable into and out from its corresponding vessel 110 independently from the other cannulas 118 or 120. Conventionally, stirring elements 114 are coupled to the head assembly 104 and lowered into the vessels 110 to agitate the dissolution media. As described in more detail below, however, implementations taught in the present disclosure eliminate the need for stirring elements 114 and associated components.

The media dispensing cannulas 118 and the media aspirating cannulas 120 communicate with a pump assembly (not shown) via fluid lines (e.g., conduits, tubing, etc.). The pump assembly may be provided in the head assembly 104 or as a separate module supported elsewhere by the frame 102 of the dissolution test apparatus 100, or as a separate module located external to the frame 102. The pump assembly may include separate pumps for each media dispensing line and/or for each media aspirating line. The pumps may be of any suitable design, one example being the peristaltic type. The media dispensing cannulas 118 and the media aspirating cannulas 120 may constitute the distal end sections of corresponding fluid lines and may have any suitable configuration for dispensing or aspirating liquid (e.g., tubes, hollow probes, nozzles, etc.). In the present context, the term “cannula” simply designates a small liquid conduit of any form that is insertable into a vessel 110.

In a typical operation, each vessel 110 is filled with a predetermined volume of dissolution media by pumping media to the media dispensing cannulas 118 from a suitable media reservoir or other source (not shown). One of the vessels 110 may be utilized as a blank vessel and another as a standard vessel in accordance with known dissolution testing procedures. Dosage units are dropped either manually or automatically into one or more selected media-containing vessels 110. Conventionally, a stirring element 114 (or other agitation or USP-type device) is rotated within each vessel 110 at a predetermined rate and duration within the test solution as the dosage units dissolve. In other types of tests, a cylindrical basket or cylinder (not shown) loaded with a dosage unit is substituted for each stirring element 114 and rotates or reciprocates within the test solution. By contrast, as described further below, agitating instruments requiring residence in the vessels (such as paddles, baskets, and the like) are eliminated according to teachings in the present disclosure. For any given vessel 110, the temperature of the media may be maintained at a prescribed temperature (e.g., approximately 37+/−0.5° C.) if certain USP dissolution methods are being conducted. Media temperature is maintained by immersion of each vessel 110 in the water bath of water bath container 108, or alternatively by direct heating as described previously. The various operative components 118, 120, 122 provided may operate continuously in the vessels 110 during test runs. Alternatively, the operative components 118, 120, 122 may be lowered manually or by an automated assembly 104 or 138 into the corresponding vessels 110, left to remain in the vessels 110 only while sample measurements are being taken at allotted times, and at all other times kept outside of the media contained in the vessels 110. In some implementations, submerging the operative components 118, 120, 122 in the vessel media at intervals may reduce adverse effects attributed to the presence of the operative components 118, 120, 122 within the vessels 110. During a dissolution test, sample aliquots of media may be pumped from the vessels 110 via the media aspiration cannulas 120 and conducted to an analyzing device (not shown) such as, for example, a spectrophotometer to measure analyte concentration from which dissolution rate data may be generated. In some procedures, the samples taken from the vessels 110 are then returned to the vessels 110 via the media dispensing cannulas 118 or separate media return conduits. Alternatively, sample concentration may be measured directly in the vessels 110 by providing fiber-optic probes as appreciated by persons skilled in the art. After a dissolution test is completed, the media contained in the vessels 110 may be removed via the media aspiration cannulas 120 or separate media removal conduits.

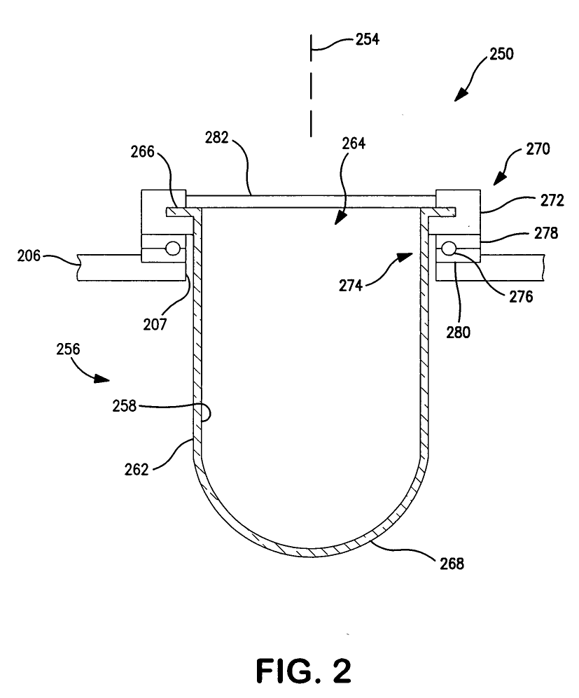

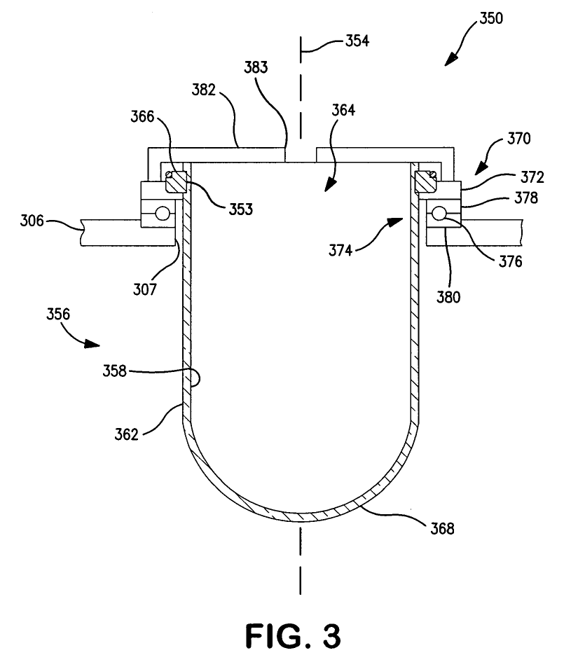

FIG. 2 is a cross-sectional elevation view of an example of a rotatable vessel 250 configured to agitate the liquid contents of the vessel 250 without the use of a stirring element or other in situ instrument. The vessel 250 may be operatively installed in a dissolution test apparatus such as described above and illustrated in FIG. 1. The vessel 250 includes a vessel body 252 that is symmetrical about a central axis 254. The vessel body 252 includes a cylindrical section 256 coaxially disposed about the central axis 254. The vessel body 252 includes an inside surface 258 facing the interior of the vessel 250 and an opposing outside surface 262. The cylindrical section 256 also generally includes an upper end region at which the cylindrical section 256 circumscribes an upper opening 264 of the vessel 250, and a lower end region axially spaced from the upper end region. The vessel body 252 further includes an annular flanged section 266 that protrudes outwardly from the upper end region, typically at or proximate to the upper opening 264. The vessel body 252 may have a unitary construction in which the flanged section 266 is formed integrally with the vessel body 252, as illustrated in FIG. 2. Alternatively, the flanged section 266 may be a separate component that is attached to the vessel body 252, as described below and illustrated in FIG. 3. The vessel body 252 also includes a bottom section 268 adjoining the cylindrical section 256 at the lower end region. The bottom section 268 may be generally hemispherical as illustrated or may have an alternate shape. For example, the bottom section 268 may be flat, dimpled, or have a peak extending upwardly into the interior of the vessel. In a typical implementation, the vessel body 252 is fabricated from a glass material having a composition suitable for dissolution testing or other analytical techniques as appreciated by persons skilled in the art. Alternatively, the vessel body 252 may be fabricated from a suitable polymeric material.

FIG. 2 also illustrates a vessel support member 206 such as may be provided with a dissolution test apparatus. The vessel support member 206 includes one or more vessel mounting sites at which a like number of vessels 250 may be mounted. At each vessel mounting site, an inside edge or wall 207 of the vessel support member 206 defines an aperture through which the vessel 250 extends.

As also illustrated in FIG. 2, the vessel 250 further includes an annular rotary member 270. The rotary member 270 may be secured to the flanged section 266 by any means effective to ensure that the vessel body 252 rotates with the rotary member 270 about the central axis 254. As examples, the rotary member 270 may be press-fitted, bonded or adhered to the flanged section 266, or alternatively may be coupled to the flanged section 266 by any suitable fastening means such as clamps, screws, pins or the like. The rotary member 270 may be generally concentrically positioned relative to the flanged section 266 so as not to obstruct the upper opening 264 of the vessel 250 in any manner. The rotary member 270 may include a drive coupling section 272 configured to engage a drive system utilized to actuate rotary motion of the vessel 250 about the central axis 254. Examples of the drive coupling section 272 and the drive system are described in detail below.

The rotary member 270 may be coupled to an annular bearing 274 that is mounted to the vessel support member 206. The bearing 274 may have any configuration suitable for supporting the vessel 250 and enabling the rotary member 270 and the vessel body 252 to rotate freely about the central axis 254 in response to an actuating output received from the associated drive system. In the illustrated example, the bearing 274 includes a series of balls 276 (or pins, needles, rollers, or the like) circumferentially arranged about the central axis 254. As appreciated by persons skilled in the art, the arrangement of the balls 276 may be maintained by a suitable retaining element (not shown) such as a frame, cage, carriage or the like. The balls 276 are interposed between a movable bearing portion 278 and a stationary bearing portion 280, each of which may include annular raceways on which the balls 276 are free to rotate. The movable bearing portion 278 may be attached to or form a part of the rotary member 270. The movable bearing portion 278 is movable in the sense that it rotates together with the rotary member 270 and the vessel body 252 about the central axis 254. The stationary bearing portion 280 may be attached to or form a part of the vessel support member 206.

FIG. 2 also illustrates an optional vessel cover (or evaporation cover) 282 that may be employed to span the upper opening 264 of the vessel 250 to minimize loss of media via evaporation. Such a vessel cover 282 may be mounted, for example, on the flanged section 266 or on the rotary member 270 of the vessel 250 and thus rotates with the vessel 250. As shown in FIG. 2, an advantage of providing the vessel 250 with rotational capability and consequently eliminating the use of an in situ stirring instrument is that the vessel cover 282 may have a completely continuous construction. That is, the vessel cover 282 need not have any apertures as compared to conventional evaporation covers that must accommodate the use of in situ operative components such as those described earlier in the present disclosure. Accordingly, evaporation loss is minimized.

FIG. 3 is a cross-sectional elevation view of another example of a rotatable vessel 350. The vessel 350 illustrated in FIG. 3 is similar to the vessel 250 illustrated in FIG. 2, except that the vessel body 352 illustrated in FIG. 3 has a two-piece construction in which the flanged section 366 is a physically separate component attached to the vessel body 352 by any suitable means. For example, the flanged section 366 may be a ring-shaped structure that is inserted into a circumferential groove 353 of the vessel body 352 and then tightened by a fastener such as a tangentially oriented screw. The vessel body 352 illustrated in FIG. 3 may be similar to or a modification of one of the vessels disclosed in above-referenced U.S. Pat. Nos. 6,562,301 and 6,673,319. The rotary member 370 and the bearing 374 provided with the vessel 350 illustrated in FIG. 3 function similarly to the like components illustrated in FIG. 2, modified or adapted as necessary to accommodate the removable flanged section 366. In a typical implementation, the removable flanged section 366 is fabricated from a polymeric material.

FIG. 3 also illustrates an optional vessel cover 382 that may be employed to span the upper opening 364 of the vessel 350 to minimize loss of media via evaporation. Similar to the vessel cover 282 illustrated in FIG. 2, the vessel cover 382 illustrated in FIG. 3 may be mounted to the flanged section 366 or the rotary member 370 such that it rotates with the vessel 350. Unlike the vessel cover 282 of FIG. 2, the vessel cover 382 of FIG. 3 has a small hole 383 positioned coaxially with the central axis 354. Thus, the position of the hole 383 does not change with rotation of the vessel cover 382, thereby enabling the insertion and removal of an instrument such as a probe or cannula while the vessel 350 is rotating. Because the vessel cover 382 has only a single small hole 383, evaporation loss is minimized as compared with conventional stationary vessel covers that have several holes for accommodating several types of instruments. The vessel cover 382 of FIG. 3 may be employed with the vessel 250 of FIG. 2. Likewise, the vessel cover 282 of FIG. 2 may be employed with the vessel 350 of FIG. 3.

In alternative implementations, the vessel cover 282 or 382 may be stationary such that the vessel 250 or 350 rotates relative to the vessel cover 282 or 382. For example, the vessel cover 282 or 382 may be coupled to the vessel 250 or 350 via a bearing. In another example, the vessel cover 282 or 382 may be supported by the dissolution test apparatus in a position directly over the vessel 250 or 350 such that the vessel cover 282 or 382 spans the upper opening 264 or 364 of the vessel 250 or 350.

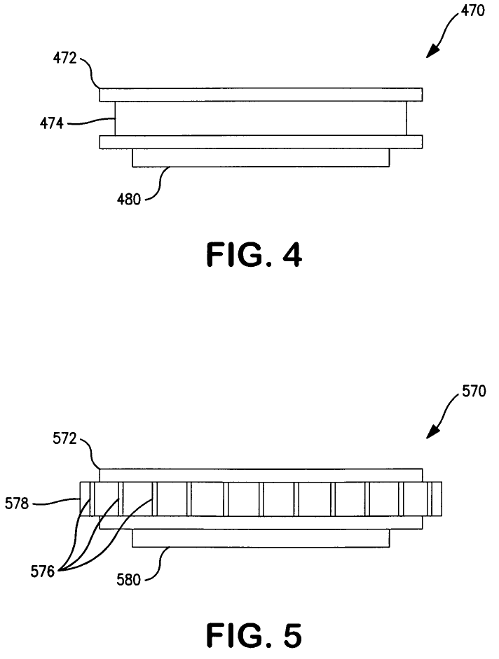

FIG. 4 is an elevation view of an example of a rotary member 470 that may be provided with a vessel such as illustrated in FIG. 2 or 3. The rotary member 470 includes a drive coupling section or portion 472 as a means for engaging a drive system such that the rotary member 470 is driven to rotate in response to a driving output from the drive system. In this example, the drive coupling section 472 is configured to engage an endless member of the drive system such as a belt. The drive coupling section 472 may include an annular groove or recessed area 474 for this purpose.

FIG. 5 is an elevation view of another example of a rotary member 570 that may be provided with a vessel such as illustrated in FIG. 2 or 3. The rotary member 570 includes a drive coupling section or portion 572 configured to engage a rotating toothed component (e.g., a gear, toothed wheel, worm, etc.) of a drive system. For this purpose, the drive coupling section 572 may include a series of teeth (or pins, etc.) 576 adapted to engage the corresponding teeth (or holes, etc.) of a rotating component of the drive system. The teeth 576 of the rotary member 570 may be formed on a ring 578 that protrudes radially outwardly from the rotary member 570, as in the illustrated example. Alternatively, the teeth 576 may be formed within a groove such as the groove 474 illustrated in FIG. 4. As an alternative to coupling with a toothed component of the drive system, the teeth 576 of the rotary member 570 may be coupled to an endless chain driven by the drive system. As a further alternative, the teeth 576 of the rotary member 570 may be coupled to an endless belt similar to that illustrated in FIG. 4 in which corresponding teeth (or ribs, etc.) are formed on the endless belt to engage the teeth 576 of the rotary member 570. In addition, terms such as “teeth” 576 or “toothed” encompass similarly functioning structures such as, for example, pins configured to engage corresponding holes or recesses formed in an endless member.

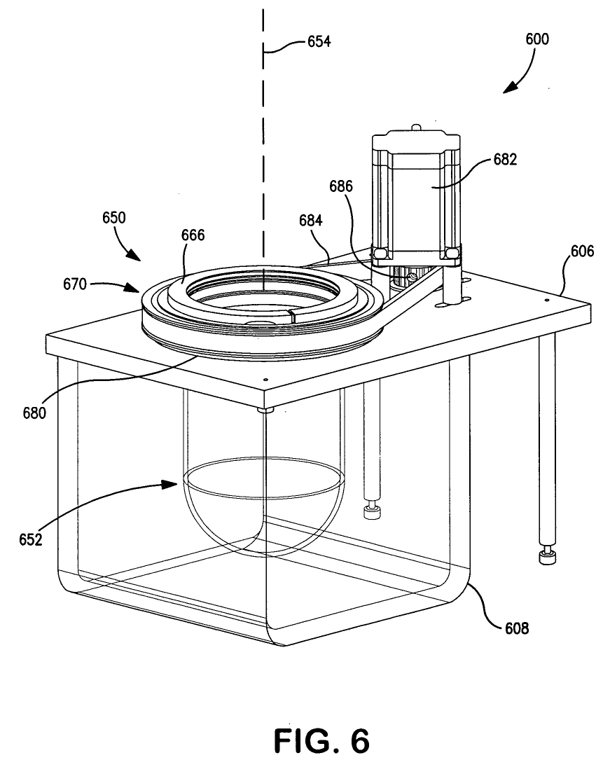

FIG. 6 is a perspective view of an example of a dissolution test apparatus 600, or a portion of a dissolution test apparatus 600, in which a vessel 650 such as illustrated in FIG. 2 or 3 may operate. Accordingly, the vessel 650 includes a vessel body 652 and a rotary member 670 secured to a flanged section 666 of the vessel 650. By example, the flanged section 666 is illustrated as being of the removable type but alternatively may be integrated with the vessel body 652 as noted above. The rotary member 670 may include a movable bearing portion as described above. The dissolution test apparatus 600 includes a vessel support member 606 that includes one or more vessel mounting sites. For simplicity, only one vessel mounting site is illustrated in FIG. 6. An aperture is formed through the thickness of the vessel support member 606 at each vessel mounting site. Each vessel mounting site may include a stationary bearing member 680 mounted at the aperture, such as described by example above in conjunction with FIGS. 2 and 3.

The dissolution test apparatus 600 further includes a vessel drive device or system 682 removably coupled to the rotary member 670 via any suitable drive coupling or linkage 684. The drive device 682 may be mounted to the vessel support member 606 or to another suitable portion of the dissolution test apparatus 600. In the illustrated example, the drive device 682 includes a motor that rotates an output shaft (not specifically shown). The drive device 682 further includes a rotary member 686 attached to and rotatable with the output shaft. The drive coupling or linkage 684 includes an endless member (e.g., a chain or belt) wrapped around the rotary member 686 of the drive device 682 and the rotary member 670 of the vessel 650. In some implementations employing a belt, the belt may also contact a non-driven idler pulley (not shown) that is mounted in an adjustable position on the vessel support member 606 to enable adjustment of belt tension.

In certain implementations as noted above, the vessel support member 606 may include more than one vessel mounting site to enable the simultaneous rotational agitation of more than vessel 650. In such cases, a drive device 682 and associated drive couplings or linkages 684 may be provided at each vessel mounting site to enable the rotations of the respective vessels 650 to be controlled independently. Alternatively, a single drive device 682 may be coupled to all vessels 650 mounted at the vessel support member 606.

The vessel 650 may be installed by inserting the vessel body 652 through the aperture and coupling the movable bearing portion of the rotary member 670 to the stationary bearing portion 680. The vessel 650 is then coupled to the drive device 682 by engaging the endless member or other type of linkage 684 with the rotary member 670 of the drive device 682 and the rotary member 670 of the vessel 650. The rotary output produced by the drive device 682 is transferred to the vessel 650 such that the vessel 650 rotates freely about a central axis 654 on the bearing formed by the movable bearing portion and the stationary bearing portion 680. During a dissolution test procedure, the vessel 650 may be filled with dissolution media and a dosage form may be introduced into the dissolution media according to any desired testing protocol. Rotation of the vessel 650 agitates the dissolution media while the dosage form is dissolving in the dissolution media, and does so without requiring the use of a paddle or other stirring element residing directly in the dissolution media.

Although the vessel 650 rotates freely about a central axis 654, the rotation is controlled by the drive device 682. The drive device 682 may communicate by wired or wireless means with a control unit provided with the dissolution test apparatus 600, thereby enabling a user to input the operating parameters of the drive device 682 and/or the control unit to execute a programmed set of instructions that control the operating parameters. It can be seen, then, that the rotation of the vessel 650 and thus agitation of the dissolution media may be tailored to a particular dissolution test in any desired manner. For instance, the vessel 650 may be rotated at a desired rotational speed. The vessel 650 may be rotated in an on/off (start/stop) fashion or in a continuous fashion. The rotational speed may be constant or vary over time according to a desired stepped speed profile or continuous speed profile such as, for example, a ramp, a sawtooth wave, a square wave, a sinusoidal wave, etc.

The dissolution test apparatus 600 illustrated in FIG. 6 may include a bath container 608 to maintain the dissolution media in the vessel(s) 650 at a desired temperature as described above in conjunction with FIG. 1. The immersion of the vessel(s) 650 in the heat transfer medium contained in the bath container 608 does not affect the controlled rotation of the vessel(s) 650. The dissolution test apparatus 600 may include other features described above in conjunction with FIG. 1. As examples, the dissolution test apparatus 600 may include cannulas and associated liquid conduits for transferring liquid media to and from the vessels 650, as well as other operative components such as temperature probes and fiber-optic probes. The dissolution test apparatus 600 may include a head assembly for housing a number of components and a structural frame for mounting a number of components as described above in conjunction with FIG. 1. An advantage of the presently disclosed dissolution test apparatus 600, however, is the elimination of in situ stirring elements. Therefore, a head assembly is not required to be located directly over the vessels 650 while the vessels 650 are rotating or otherwise during dissolution testing, thereby enabling facilitating visual inspection of the vessels 650 and allowing greater access to the vessels 650.

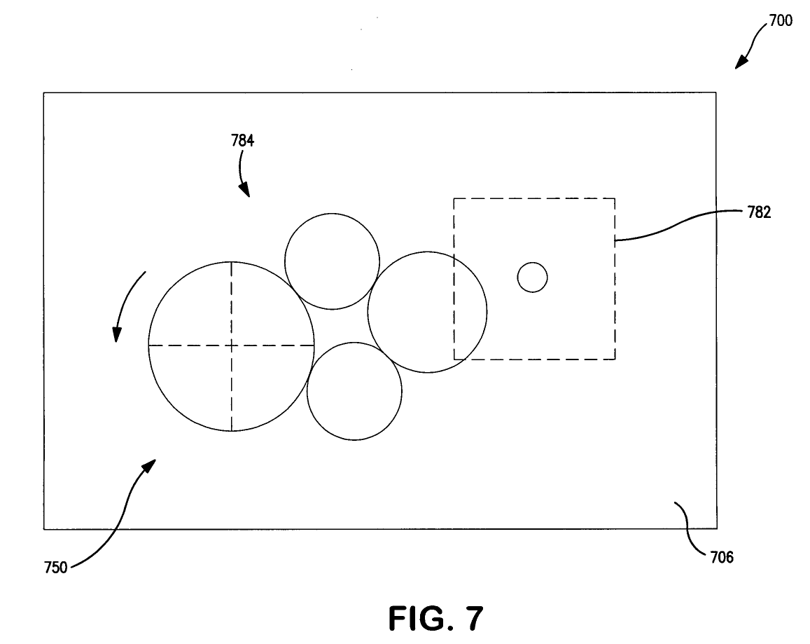

FIG. 7 is a schematic top plan view of another example of a dissolution test apparatus 700, or a portion of a dissolution test apparatus 700, in which a vessel 750 such as illustrated in FIG. 2 or 3 may operate. Similar to the example illustrated in FIG. 6, the dissolution test apparatus 700 illustrated in FIG. 7 includes one or more rotatable vessels 750 and drive units 782 mounted at a vessel support member 706. In the present example, the dissolution test apparatus 700 includes a drive coupling or linkage 784 that includes one or more rotatable toothed elements (e.g., gears, wheels, worms, etc.) that couple the rotary output of the drive unit 782 to the rotary member of the vessel 750.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be further understood that various aspects or details of the invention may be changed without departing from the scope of the invention. Furthermore, the foregoing description is for the purpose of illustration only, and not for the purpose of limitation—the invention being defined by the claims.

What is claimed is:

1. A rotatable vessel comprising:
a vessel body including a cylindrical section coaxially disposed about a central axis of the vessel and circumscribing an upper opening, a bottom section adjoining the cylindrical section at an axial end of the cylindrical section opposite to the upper opening, and a flanged section extending radially outward from the cylindrical section proximate to the upper opening; and
a rotary member secured to the flanged section, the rotary member including a drive coupling section configured to be coupled to a drive device wherein the vessel body and the rotary member are rotatable together about the central axis, and a movable bearing portion configured to be coupled to a stationary bearing portion supporting the rotary member.

2. The rotatable vessel of claim 1, wherein the vessel body has a unitary construction in which the flanged section is integrally formed with the cylindrical section.

3. The rotatable vessel of claim 1, wherein the flanged section and the cylindrical section are separate components and the flanged section is secured to the cylindrical section.

4. The rotatable vessel of claim 1, wherein the drive coupling section has a groove configured to be coupled to an endless member driven by the drive device.

5. The rotatable vessel of claim 1, wherein the drive coupling section includes a driven toothed portion configured to be coupled to a corresponding driving portion of the drive device.

6. A dissolution test apparatus comprising:
a vessel support member including a vessel mounting site, the vessel mounting site having an aperture and including a stationary bearing portion mounted at the aperture;
a rotary member rotatable about a central axis of the aperture and including a movable bearing portion coupled to the stationary bearing portion;
a drive device mounted to the vessel support member; and
a drive linkage coupling the drive device to the rotary member, wherein the drive device actuates rotation of the rotary member about the central axis and relative to the stationary bearing portion via the drive linkage.

7. The dissolution test apparatus of claim 6, further including a vessel mounted at the vessel mounting site, the vessel including a cylindrical section coaxially disposed about the central axis and circumscribing an upper opening, a bottom section adjoining the cylindrical section at an axial end of the cylindrical section opposite to the upper opening, and a flanged section radially outward from the cylindrical section proximate to the upper opening, wherein the cylindrical section extends through the aperture, the flanged section is secured to the rotary member, and the vessel is rotatable with the rotary member about the central axis.

8. The dissolution test apparatus of claim 7, further including an evaporation cover mounted to the vessel and rotatable with the vessel, the evaporation cover spanning the upper opening continuously without any holes.

9. The dissolution test apparatus of claim 7, further including an evaporation cover mounted to the vessel and rotatable with the vessel, the evaporation cover spanning the upper opening and having a single hole disposed coaxially with the central axis.

10. The dissolution test apparatus of claim 7, further including an evaporation cover spanning the upper opening, wherein the vessel is rotatable relative to the evaporation cover.

11. The dissolution test apparatus of claim 7, further including an evaporation cover spanning the upper opening and including a cover bearing coupled to the vessel, wherein the vessel is rotatable relative to the evaporation cover.

12. The dissolution test apparatus of claim 7, further including an evaporation cover spanning the upper opening and fixedly coupled to the dissolution test apparatus, wherein the vessel is rotatable relative to the evaporation cover.

13. The dissolution test apparatus of claim 6, further including an evaporation cover fixedly coupled to the dissolution test apparatus at a position above the aperture.

14. The dissolution test apparatus of claim 6, wherein the drive linkage includes an endless member coupling the drive device to the rotary member.

15. The dissolution test apparatus of claim 6, wherein the rotary member includes a driven toothed portion and the drive linkage includes a drivable toothed member coupling the drive device to the driven toothed portion.

16. A method for agitating dissolution media contained in a vessel mounted at a dissolution test apparatus, the method comprising:
securing a rotary member to a flanged section of the vessel;
installing the vessel at the dissolution test apparatus by inserting the vessel through an aperture of a vessel support member of the dissolution test apparatus and coupling a movable bearing portion of the rotary member to a stationary bearing portion of the vessel support member;
coupling the rotary member to a drive device; and
rotating the vessel about a central axis of the vessel by operating the drive device, wherein the rotation agitates the dissolution media contained in the vessel.

17. The method of claim 16, further including operating the drive device to control the rotational speed of the vessel according to a desired speed profile.

18. The method of claim 16, wherein coupling the rotary member to the drive device includes coupling an endless member to the rotary member and the drive device.

19. The method of claim 16, wherein coupling the rotary member to the drive device includes coupling a toothed portion of the rotary member to the drive device or to a drive

20. The method of claim 16, further including introducing a dosage form into the vessel, and dissolving the dosage form in the dissolution media while rotating the vessel and further including transporting at least a portion of the dissolution media from the vessel to an analytical instrument to acquire dissolution data.
